(19) United States
(12) Patent Application Publication
(10) Pub. No.: US 2020/0047180 A1
(43) Pub. Date: Feb. 13, 2020

(54) CENTRIFUGAL DEVICE

(71) Applicant: ELECTRONICS AND TELECOMMUNICATIONS RESEARCH INSTITUTE, Daejeon (KR)

(72) Inventors: Kwang Hyo CHUNG, Daejeon (KR); Chul HUH, Daejeon (KR); Bong Kyu KIM, Daejeon (KR); Jin Tae KIM, Daejeon (KR); Hyung Wook NOH, Daejeon (KR); Joo Yong SIM, Daejeon (KR); Chang-Geun AHN, Sejong (KR); Eun-Ju JEONG, Daejeon (KR)

(21) Appl. No.: 16/536,031

(22) Filed: Aug. 8, 2019

(30) Foreign Application Priority Data
Aug. 9, 2018 (KR) 10-2018-0093382
Dec. 27, 2018 (KR) 10-2018-0171315

(51) Int. Cl. B01L 3/00

(52) U.S. Cl. CPC B01L 3/5021; B01L 3/502753; B01L 2300/0681; B01L 2400/0409; B01L 2300/0864; B01L 3/502715

(57) ABSTRACT

Provided is a centrifugal device. The centrifugal device includes a centrifugal part configured to provide an intermediate chamber into which a centrifugal object is put and a driving part disposed on a rotation axis passing through the intermediate chamber.

### CROSS-REFERENCE TO RELATED APPLICATIONS

This U.S. non-provisional patent application claims priority under 35 U.S.C. § 119 of Korean Patent Application No. 10-2018-0093382, filed on Aug. 9, 2018, and 10-2018-0171315, filed on Dec. 27, 2018, the entire contents of which are hereby incorporated by reference.

### BACKGROUND

The present disclosure herein relates to a centrifugal device, and more particularly, to a centrifugal device in which a rotation axis passes through an intermediate chamber.

Blood may include blood particle components such as red blood cells, white blood cells, platelets, and the like and blood plasma components including water, protein, fat, saccharides, and other minerals. Such blood may be used as a sample for judging various diseases or health conditions and also may be mainly used to detect the presence or amount of a specific protein in blood.

Since the protein to be detected exists in the blood plasma components, the blood particle components may need to be removed from the blood. Thus, a process of removing the blood particle components from the blood may proceed before being put into a bio-chip. The amount of blood plasma in the blood may be about 50% to about 60%.

Separation of the blood cells and the blood plasma may be performed by a centrifugal device. The centrifugal device may be used repeatedly in the field within a short period of time. Since the blood is derived from the human body, studies are being conducted on small-capacity centrifugal devices that are capable of performing the detection by using as little blood as possible.

### SUMMARY

The present disclosure provides a centrifugal device that is capable of being simplified in volume.

The present disclosure also provides a centrifugal device that is capable of separating a small amount of blood.

The present disclosure also provides a centrifugal device that is capable of quickly performing a separation operation.

The present disclosure also provides a centrifugal device that is capable of being simply used.

The present disclosure also provides an inexpensive centrifugal device.

The present disclosure also provides a centrifugal device that is capable of even a bio-reaction at once.

The object of the present disclosure is not limited to the aforesaid, but other objects not described herein will be clearly understood by those skilled in the art from descriptions below.

An embodiment of the inventive concept provides a centrifugal device including: a centrifugal part configured to provide an intermediate chamber into which a centrifugal object is put; and a driving part disposed on a rotation axis passing through the intermediate chamber.

In an embodiment, the intermediate chamber may have a pot shape.

In an embodiment, the centrifugal part may include a first member and a second member, wherein the first member may include a first inner surface configured to define an upper side of the intermediate chamber, and the second member may include a second inner surface configured to define a lower side of the intermediate chamber.

In an embodiment, the first inner surface and the rotation axis may have an acute angle therebetween, and the second inner surface and the rotation axis may have an acute angle therebetween.

In an embodiment, the centrifugal part may further include a third member, and the third member may be disposed between the first member and the second member to connect the first member to the second member and includes a third inner surface configured to define an outer chamber communicating with the intermediate chamber.

In an embodiment, the outer chamber may surround the rotation axis and a portion of the intermediate chamber.

In an embodiment, the first member may include a first upper member including the first inner surface and a second lower member including a lower surface configured to define the outer chamber, and the second member may include a second lower member including the second inner surface and a second upper member including an upper surface configured to define the outer chamber.

In an embodiment, the centrifugal device may further include a connection part configured to connect the centrifugal part to the driving part, wherein the driving part may rotate the connection part and the centrifugal part.

In an embodiment of the inventive concept, a centrifugal device includes a centrifugal part configured to provide an intermediate chamber into which a centrifugal object is put, wherein the centrifugal part is rotated about a rotation axis passing through the intermediate chamber.

In an embodiment, the intermediate chamber may have a pot shape.

In an embodiment, the centrifugal part may include a first member and a second member, wherein the first member may include a first inner surface configured to define an upper side of the intermediate chamber, and the second member may include a second inner surface configured to define a lower side of the intermediate chamber.

In an embodiment, the first inner surface and the rotation axis may have an acute angle therebetween, and the second inner surface and the rotation axis may have an acute angle therebetween.

In an embodiment of the inventive concept, a centrifugal device includes a centrifugal part,

wherein the centrifugal part includes a first member and a second member, the first member provides a first intermediate chamber through which a rotation axis of the centrifugal part passes, the second member provides a second intermediate chamber through which the rotation axis of the centrifugal part passes, and the first intermediate chamber and the second intermediate chamber communicate with each other.

In an embodiment, the first member may include a first inner surface configured to define the first intermediate chamber, and the second member may include a second inner surface configured to define the second intermediate chamber.

In an embodiment, the first inner surface and the rotation axis may have an acute angle therebetween, and the second inner surface and the rotation axis may have an acute angle therebetween.

The details of other embodiments of the present invention are not limited to those described above, and other matters not mentioned may be clearly understood by those skilled in the art from the following description.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view of a centrifugal device according to exemplary embodiments of the inventive concept;

FIG. 2 is an exploded cross-sectional view of the centrifugal device according to exemplary embodiments of the inventive concept;

FIG. 3 is a cross-sectional view illustrating a centrifugal part of the centrifugal device according to exemplary embodiments of the inventive concept;

FIG. 4 is a flowchart illustrating a centrifugal method of the centrifugal device according to exemplary embodiments of the inventive concept;

FIGS. 5 to 10 are cross-sectional views illustrating an operation principle of the centrifugal part of the centrifugal device according to exemplary embodiments of the inventive concept;

FIGS. 11 and 12 are cross-sectional views illustrating an operation principle of the centrifugal part of the centrifugal device according to exemplary embodiments of the inventive concept;

FIG. 13 is a cross-sectional view illustrating a portion of the centrifugal part of the centrifugal device according to exemplary embodiments of the inventive concept;

FIG. 14 is a cross-sectional view illustrating a portion of the centrifugal part of the centrifugal device according to exemplary embodiments of the inventive concept;

FIG. 15 is a cross-sectional view illustrating a portion of the centrifugal part of the centrifugal device according to exemplary embodiments of the inventive concept; and

FIG. 16 is a cross-sectional view illustrating a centrifugal part of the centrifugal device according to exemplary embodiments of the inventive concept.

### DETAILED DESCRIPTION

Exemplary embodiments of technical ideas of the inventive concept will be described with reference to the accompanying drawings so as to sufficiently understand constitutions and effects of the inventive concept. The technical ideas of the inventive concept may, however, be embodied in different forms and should not be construed as limited to the embodiment set forth herein. Rather, these embodiments are provided so that this disclosure will be thorough and complete, and will fully convey the scope of the present invention to those skilled in the art. Further, the present invention is only defined by scopes of claims.

Like reference numerals refer to like elements throughout. The embodiments in the detailed description will be described with exemplary block diagrams, perspective views, and/or cross-sectional views as ideal exemplary views of the inventive concept. In the figures, the dimensions of regions are exaggerated for effective description of the technical contents. Areas exemplified in the drawings have general properties and are used to illustrate a specific shape of a device. Thus, this should not be construed as limited to the scope of the inventive concept. Also, although various terms are used to describe various components in various embodiments of the inventive concept, the component are not limited to these terms. These terms are only used to distinguish one component from another component. The embodiments described and exemplified herein include complementary embodiments thereof.

In the following description, the technical terms are used only for explaining a specific exemplary embodiment while not limiting the present invention. In this specification, the terms of a singular form may comprise plural forms unless specifically mentioned. The meaning of ‘comprises’ and/or ‘comprising’ does not exclude other components besides a mentioned component.

Hereinafter, the present disclosure will be described in detail by explaining preferred embodiments of the technical ideas of the inventive concept with reference to the attached drawings.

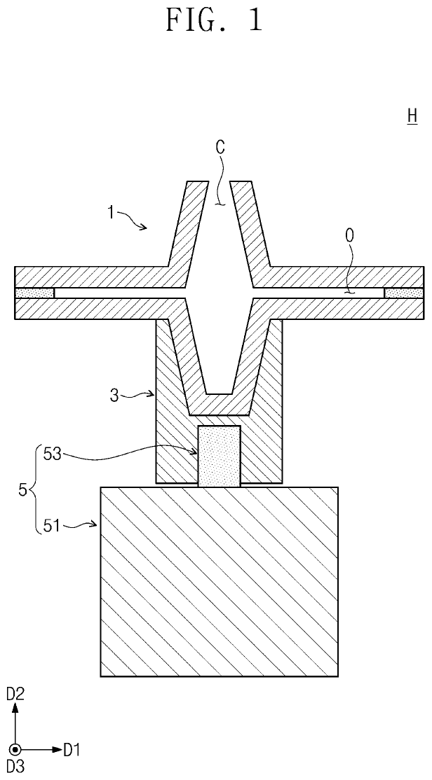

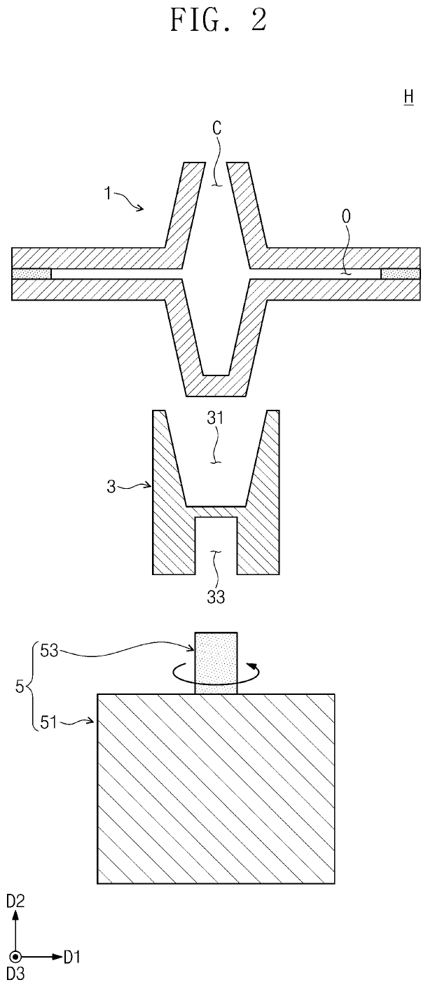

FIG. 1 is a cross-sectional view of a centrifugal device according to exemplary embodiments of the inventive concept, and FIG. 2 is an exploded cross-sectional view of the centrifugal device according to exemplary embodiments of the inventive concept.

Hereinafter, in FIG. 1, a right direction may be called a first direction D1, an upward direction may be called a second direction D2, and a forward direction that is substantially perpendicular to the first direction D1 and the second direction D2 may be called a third direction D3.

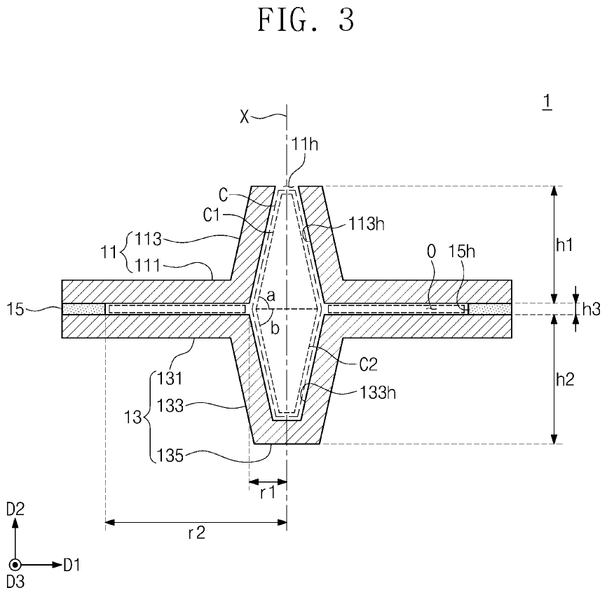

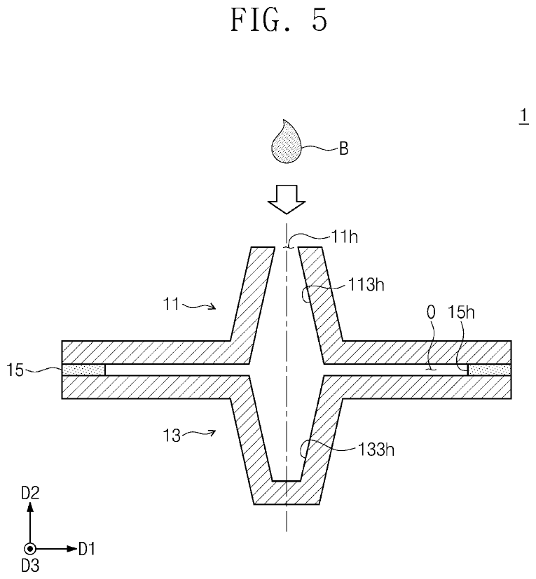

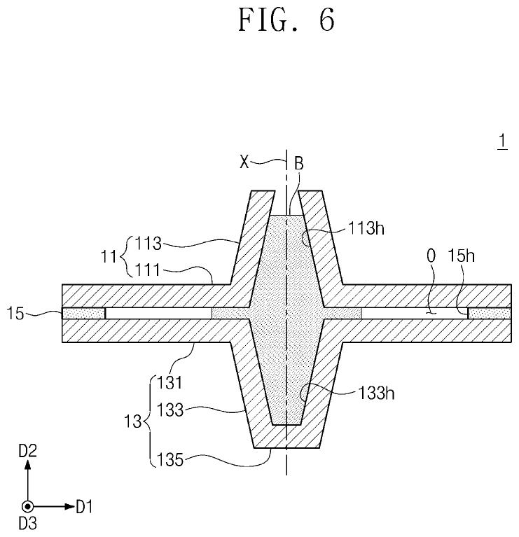

Referring to FIGS. 1 and 2, a centrifugal device H may include a centrifugal part 1, a driving part 5, and a connection part 3. An intermediate chamber C and an outer chamber O may be provided in the centrifugal part 1. The intermediate chamber C may be disposed at a center of the centrifugal part 1. The intermediate chamber C may include a first intermediate chamber C1 (see FIG. 3) and a second intermediate chamber C2 (see FIG. 3). The intermediate chamber C may have a pot shape. The outer chamber O may surround the intermediate chamber C. In embodiments, the outer chamber O may have a volume that corresponds to about 40% to about 50% of a volume of an centrifugal object B (see FIGS. 5 and 6). However, the embodiment is not limited thereto. For example, a mechanism that is capable of adjusting a volume of the outer chamber O may be provided. The driving part 5 may rotate the centrifugal part 1. In embodiments, the driving part 5 may include a motor. The driving part 5 may include a driving body 51 and a driving axis 53. The driving body 51 may rotate the driving axis 53. The driving axis 53 may be coupled to the centrifugal part 1 by using the connection part 3 as a medium so as to be rotated. The connection part 3 may connect the centrifugal part 1 to the driving part 5. The connection part 3 may include a centrifugal part connection part 31 and a driving axis connection hole 33. The centrifugal part connection part 31 may be recessed in an opposite direction of the second direction D2. The centrifugal part 1 may be inserted into the centrifugal part connection part 31. The driving axis connection hole 33 may be recessed in the second direction D2. The driving axis 53 may be inserted into the driving axis connection hole 33.

FIG. 3 is a cross-sectional view illustrating the centrifugal part of the centrifugal device according to exemplary embodiments of the inventive concept.

Referring to FIG. 3, the centrifugal part 1 may include a first member 11, a second member 13, and a third member 15.

In embodiments, the first member 11 may have a shape that is symmetrical with respect to a rotation axis X. The rotation axis X may be substantially parallel to the second direction D2. The first member 11 may include a first lower member 111 and a first upper member 113. The first lower member 111 may be deployed on a plane defined by the first direction D1 and the third direction D3. The first lower member 111 may have a donut shape. The first upper member 113 may extend from the first lower member 111 in the second direction D2. The first upper member 113 may have a height h1. The first upper member 113 may have a truncated conical shape having a cross-sectional area that gradually decreases in the second direction D2. The first upper member 113 and the first direction D1 may have a predetermined angle a therebetween. The predetermined angle a may be between about 0 degree and about 90 degrees. In detail, the predetermined angle a may be greater about 0 degree and less than about 90 degrees. In more detail, the predetermined angle a may range of about 45 degrees to about 80 degrees. The inside of the first upper member 113 may be empty. The first intermediate chamber C1 may be provided in the first upper member 113. The first intermediate chamber C1 may be defined by a first inner surface 113h. The first inner surface 113h may be subjected to hydrophilic or hydrophobic treatment. A protrusion (not shown) may be additionally provided on the first inner surface 113h. An upper end of the first upper member 113 may be opened. The first intermediate chamber C1 may communicate with the outside through an inlet 11h. A sealing member (not shown) that covers the inlet 11h may be further provided. In embodiments, the first member 11 may be made of a transparent material. The first member 11 may be made of plastic. In embodiments, the first member 11 may be disposable.

The second member 13 may be spaced apart from the first member 11 in the second direction D2. In embodiments, the second member 13 may have a shape that is symmetrical with respect to the rotation −axis X. The rotation axis X may be substantially parallel to the second direction D2. The second member 13 may include a second upper member 131, a second lower member 133, and a support member 135. The second upper member 131 may be deployed on the plane defined by the first direction D1 and the third direction D3. The second upper member 131 may have a donut shape. The second lower member 133 may extend from the second upper member 131 in a direction that is opposite to the second direction D2. The second lower member 133 may have a height −h2. The second lower member 133 may have a truncated conical shape having a cross-sectional area that gradually decreases in the direction that is opposite to the second direction D2. The second lower member 133 and the first direction D1 may have a predetermined angle b therebetween. The predetermined angle b may be between about 0 degree and about 90 degrees. In detail, the predetermined angle b may be greater about 0 degree and less than about 90 degrees. In more detail, the predetermined angle b may range of about 45 degrees to about 80 degrees. The inside of the second lower member 133 may be empty. The second intermediate chamber C2 may be provided in the second lower member 133. The second intermediate chamber C2 may be defined by a second inner surface 133h. The second inner surface 133h may be subjected to hydrophilic or hydrophobic treatment. A protrusion (not shown) may be additionally provided on the second inner surface 133h. The support member 135 may be coupled to a lower portion of the second lower member 133. The second member 13 may be made of plastic. In embodiments, the second member 13 may be disposable.

The rotation axis X may pass through the intermediate chamber C. A radius of the intermediate chamber C about the rotation axis X may be r1 at a portion at which the first intermediate chamber C1 and the second intermediate chamber C2 meet each other.

The third member 15 may be disposed between the first member 11 and the second member 13. In embodiments, the third member 15 may has a donut shape. The third member 15 may bond the first member 11 to the second member 13. In embodiments, the third member 15 may include a double-sided tape, silicone, rubber, and the like. The third member 15 may have a height h3. In embodiments, the height h3 may be less than each of the heights h1 and h2. A distance between the third member 15 and the rotation axis X may be r2. The distance r2 may be greater than the radius r1. The outer chamber O may be defined by a third inner surface 15h of the third member 15, a bottom surface of the first lower member 111, and a top surface of the second upper member 131. The outer chamber O may communicate with the intermediate chamber C.

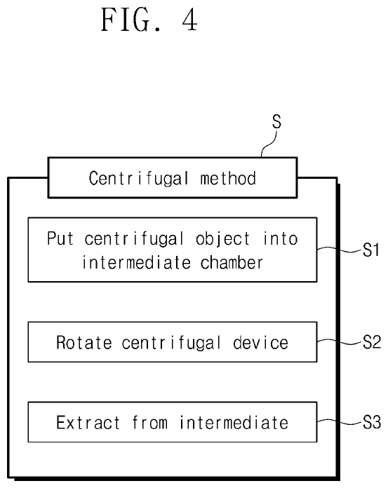

FIG. 4 is a flowchart illustrating a centrifugal method of the centrifugal device according to exemplary embodiments of the inventive concept.

Referring to FIG. 4, a centrifugal method S of the centrifugal device may include a process (S1) of putting a centrifugal object into the intermediate chamber, a process (S2) of rotating the centrifugal device, and an extraction process (S3) from the intermediate chamber. Hereinafter, each of the processes of the centrifugal method S will be described in detail with reference to FIGS. 5 to 10.

FIGS. 5 to 10 are cross-sectional views illustrating an operation principle of the centrifugal part of the centrifugal device according to exemplary embodiments of the inventive concept.

Referring to FIG. 5, a centrifugal object B may be put into the centrifugal part 1 through the inlet 11h. The putting of the centrifugal object B may be performed by a pipette. The centrifugal object B may drop in a direction that is opposite to the second direction D2. The centrifugal object B may move by gravity acting in the direction that is opposite to the second direction D2. The centrifugal object B may include two or more materials having different densities. In embodiments, the centrifugal object B may include blood. However, the embodiments are not limited thereto. For example, the centrifugal object B may include other liquids.

Referring to FIG. 6, the centrifugal object B may be disposed in the intermediate chamber C (see FIG. 3) of the centrifugal part 1. The centrifugal object B may contact the first inner surface 113h and the second inner surface 133h. A portion of the centrifugal object B may be disposed in the outer chamber O according to an amount of centrifugal object B.

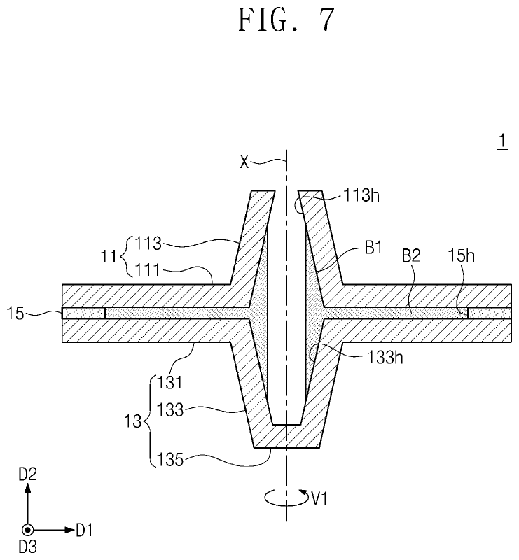

Referring to FIG. 7, the centrifugal object B may be rotated. In more detail, the centrifugal object B may be rotated by the driving part 5 (see FIGS. 1 and 2). The centrifugal object B may be rotated about the rotation axis X. The centrifugal object B may be rotated at a constant speed. The centrifugal object B may be rotated at a speed V1. When the centrifugal object B is rotated at the speed V1, a portion of the centrifugal object B may move in the first direction D1 and the direction that is opposite to the first direction D1. A portion of the centrifugal object B may further move to the outer chamber O. A portion of the centrifugal object B, which remains in the intermediate chamber, may be called a centrifugal object first portion B1, and a portion the centrifugal object B, which is inserted into the outer chamber O, may be called a centrifugal object second portion B2. In embodiments, the centrifugal object second portion B2 may contact the third inner surface 15h of the third member 15. The centrifugal object B may not be disposed any more in the central portion of the intermediate chamber. The central portion of the intermediate chamber may be empty. The centrifugal object B may not be provided at a portion through which the rotation axis X passes.

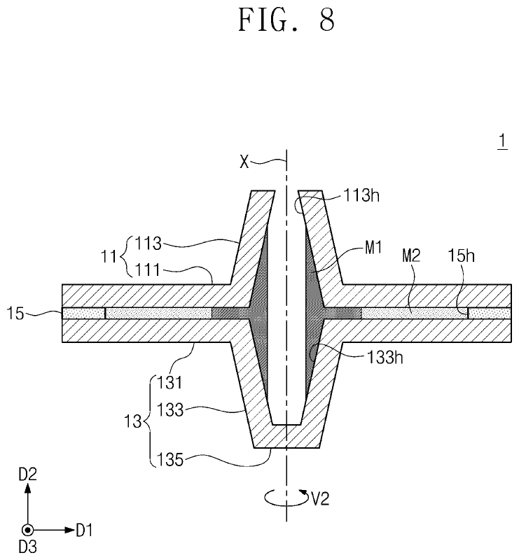

Referring to FIG. 8, the centrifugal part 1 may be rotated at a speed V2. In embodiments, the speed V2 may be greater than the speed V1. Thus, the centrifugal part 1 may be more quickly rotated. The centrifugal object B may be separated. A material having a high density may be away from the rotation axis X so as to be lean to the third inner surface 15h. The separated material having the high density may be called a second material M2. A material having a low density may be distributed relatively close to the rotation axis X. The separated material having the low density may be called a first material M1. In embodiments, when the centrifugal object B is the blood, the first material M1 may include blood plasma. The second material M2 may include blood cells. That is, the blood plasma and the blood cells may be separated from each other by the rotation. The rotation of the centrifugal part 1 may be continued until the blood plasma and the blood cells are adequately separated from each other. When the first member 11 is transparent, the separation of the blood plasma and the blood cells may be confirmed by naked eyes. Alternatively, a separate imaging device (not shown) may be further provided to detect the separation of the blood plasma and the blood cells.

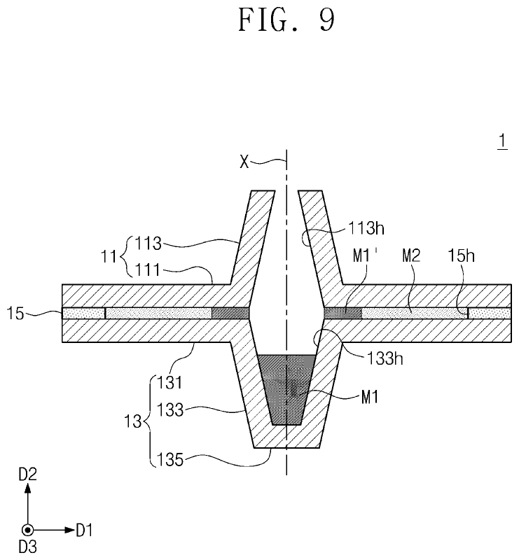

Referring to FIG. 9, the rotation of the centrifugal part 1 may be stopped. The first material M1 may be gathered on the support member 135 by the gravity. The second material M2 may be continuously disposed in the outer chamber. A portion M1′ of the first material M1 may remain in the outer chamber according to an amount of blood or a ratio of the blood cells, which are occupied in the blood.

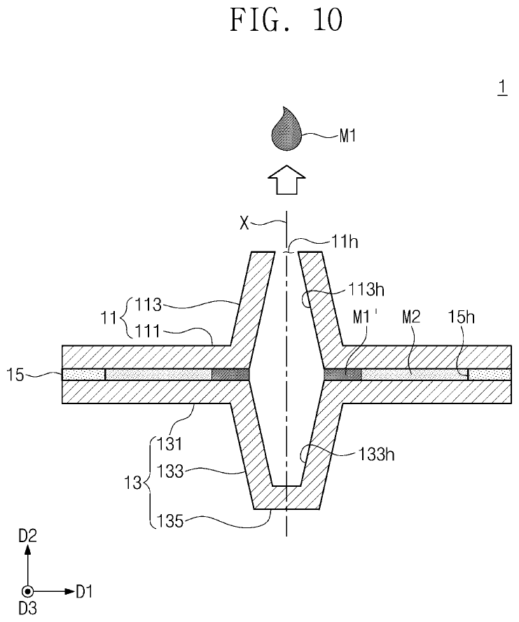

Referring to FIG. 10, the first material M1 gathered in the intermediate chamber may be extracted. In more detail, the first material M1 gathered on the support member 135 may be extracted to the outside through the inlet 11h. The extraction may be performed by the pipette. The extracted first material M1 may be used for various purposes. In embodiments, when the centrifugal object B is the blood, the first material M1 including the blood plasma may be used to perform a bio-reaction. When the volume of the outer chamber O is greater than about 40% to about 50% volume of the centrifugal object B, the extracted material may include only the blood plasma without the blood cells. The first material M1 and the second material M2 may be spaced apart from each other, and thus the purity of the first material M1 may be enhanced. Thus, accuracy of the bio-reaction may be improved.

In the centrifugal device according to exemplary embodiments of the inventive concept, since the centrifugal device is rotated about the rotation axis passing through the intermediate chamber, the centrifugal device may be reduced in volume. That is, the centrifugal object may not be put into the chamber that is far away from the rotation center but be put into the intermediate chamber through which the rotation axis passes so as to perform the centrifugal separation, thereby reducing the volume of the device. The centrifugal device that is reduced in volume may be easily used in the fields, and the price thereof may be inexpensive. Also, an amount of centrifugal object required for separation may be reduced. In the case of separating the blood, since only a small amount of blood is extracted, burden on the human body may be reduced. Furthermore, since the separation is performed within a short time, operation efficiency may be improved.

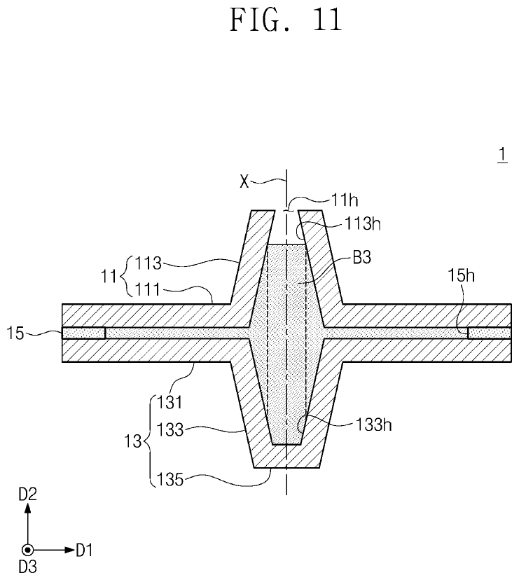

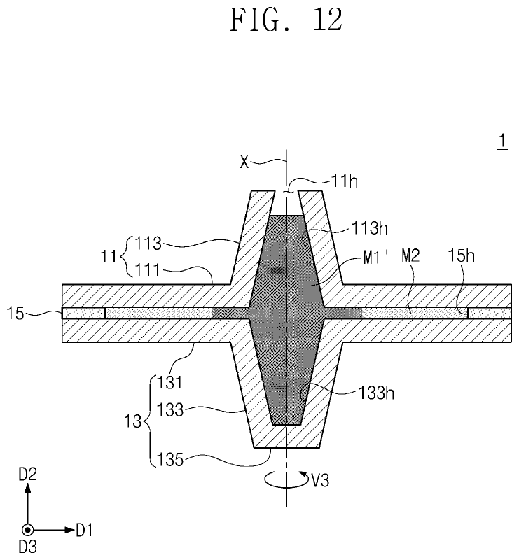

FIGS. 11 and 12 are cross-sectional views illustrating an operation principle of the centrifugal part of the centrifugal device according to exemplary embodiments of the inventive concept.

Hereinafter, the contents substantially the same as or similar to those described with reference to FIGS. 1 to 10 may be omitted for convenience.

Referring to FIG. 11, a centrifugal object B3 may be further put into the intermediate chamber through which the rotation axis X passes in the state of FIG. 8.

Referring to FIG. 10, the centrifugal part 1 may be rotated at a speed V3. The speed V3 may be greater than the speed V1. The centrifugal part 1 may be further rotated to separate a first material M1′ and a second material M2′ from each other. Thereafter, as illustrated in FIG. 10, the first material M1′ may be extracted through the inlet 11h.

The centrifugal part 1 may be rotated at the constant speed V1 to provide an empty space in the intermediate chamber through which the rotation axis X passes. Then, the centrifugal object B3 may be further put, and the centrifugal part 1 may be further rotated at the speed V3 to secure a more amount of first material M1′.

FIG. 13 is a cross-sectional view illustrating a portion of the centrifugal part of the centrifugal device according to exemplary embodiments of the inventive concept.

Hereinafter, the contents substantially the same as or similar to those described with reference to FIGS. 1 to 12 may be omitted for convenience.

Referring to FIG. 13, a fine structure 17 may be further provided on a top surface of the second upper member 131. The fine structure 17 may be disposed close to the intermediate chamber. The fine structure 17 may have a rectangular cross-section. The fine structure 17 may prevent a first material and a second material from being mixed with each other after being separated into the first material and the second material. The fine structure 17 may prevent the second material from flowing down together when the first material flows down by the gravity and surface tension. The efficiency of the centrifugal separation may be improved.

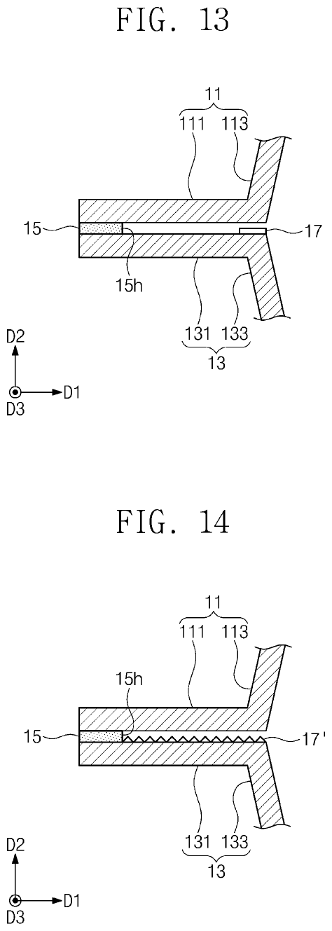

FIG. 14 is a cross-sectional view illustrating a portion of the centrifugal part of the centrifugal device according to exemplary embodiments of the inventive concept.

Hereinafter, the contents substantially the same as or similar to those described with reference to FIGS. 1 to 13 may be omitted for convenience.

Referring to FIG. 14, a fine structure 17′ may be further provided on the top surface of the second upper member 131. The fine structure 17′ may have a cross-section in which triangular shapes are arranged in the second direction D2. The fine structure 17′ may prevent a first material and a second material from being mixed with each other after being separated into the first material and the second material. The fine structure 17′ may prevent the second material from flowing down together when the first material flows down by the gravity and surface tension. The efficiency of the centrifugal separation may be improved.

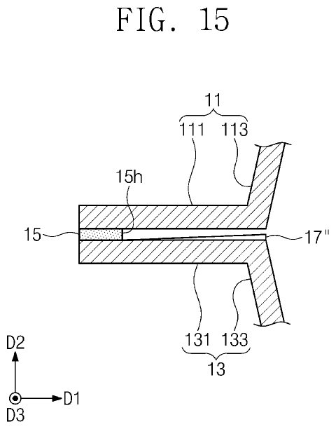

FIG. 15 is a cross-sectional view illustrating a portion of the centrifugal part of the centrifugal device according to exemplary embodiments of the inventive concept.

Hereinafter, the contents substantially the same as or similar to those described with reference to FIGS. 1 to 14 may be omitted for convenience.

Referring to FIG. 15, a fine structure 17″ may be further provided on the top surface of the second upper member 131. The fine structures 17″ may have a height that gradually increases from the third member 15 in the second direction D2. The fine structure 17″ may prevent a first material and a second material from being mixed with each other after being separated into the first material and the second material. The fine structure 17″ may prevent the second material from flowing down together when the first material flows down by the gravity and surface tension. The efficiency of the centrifugal separation may be improved.

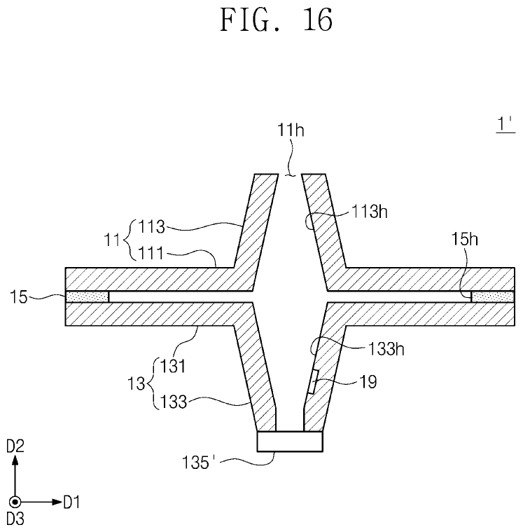

FIG. 16 is a cross-sectional view illustrating the centrifugal part of the centrifugal device according to exemplary embodiments of the inventive concept.

Hereinafter, the contents substantially the same as or similar to those described with reference to FIGS. 1 to 15 may be omitted for convenience.

Referring to FIG. 16, the centrifugal part may further include a bio-sensor 19. The bio-sensor 19 may be coupled to the second inner surface 133h. When the first material flows down to contact the bio-sensor 19, a bio-reaction may be performed on the bio-sensor 19. The bio-reaction may include an antigen-antibody reaction and the like. In embodiments, while the bio-reaction is performed, the centrifugal part 1 may be rotated.

In embodiments, a support member 135′ may include a valve. The valve may be opened. When the valve is opened, the first material on which the bio-reaction is completed may be discharged downward.

In the centrifugal device according to exemplary embodiments of the inventive concept, the bio-sensor 19 may be provided in the centrifugal part 1 to perform the bio-reaction just after the centrifugal separation. Thus, the reaction rate may be improved. A separate process of extracting the separated material through the inlet 11h may not be required. Thus, the entire processes may be simplified, and the worker may work conveniently. Furthermore, since no separate bio-sensor 19 is required, the volume of the device may be reduced. That is, the centrifugal device may be used as a reaction vessel for the bio-reaction.

According to the centrifugal device of the inventive concept, the volume may be simplified.

According to the centrifugal device of the inventive concept, the centrifugal device may separate small amount of blood.

According to the centrifugal device of the inventive concept, the separation operation may be quickly performed.

According to the centrifugal device of the inventive concept, the worker may easily use the centrifugal device in the field.

According to the centrifugal device of the inventive concept, the centrifugal device may be inexpensive.

According to the centrifugal device of the inventive concept, the centrifugal device may perform even the bio-reaction at once.

The effects of the present invention are not limited to the aforementioned object, but other effects not described herein will be clearly understood by those skilled in the art from descriptions below.

Although the embodiment of the present invention is described with reference to the accompanying drawings, those with ordinary skill in the technical field of the present invention pertains will be understood that the present invention can be carried out in other specific forms without changing the technical idea or essential features. Thus, the above-disclosed embodiments are to be considered illustrative and not restrictive.

What is claimed is:

1. A centrifugal device comprising:
a centrifugal part configured to provide an intermediate chamber into which a centrifugal object is put; and
a driving part disposed on a rotation axis passing through the intermediate chamber.

2. The centrifugal device of claim 1, wherein the intermediate chamber has a pot shape.

3. The centrifugal device of claim 1, wherein the centrifugal part comprises a first member and a second member,
wherein the first member comprises a first inner surface configured to define an upper side of the intermediate chamber, and
the second member comprises a second inner surface configured to define a lower side of the intermediate chamber.

4. The centrifugal device of claim 3, wherein the first inner surface and the rotation axis have an acute angle therebetween, and
the second inner surface and the rotation axis have an acute angle therebetween.

5. The centrifugal device of claim 4, wherein the centrifugal part further comprises a third member, and
the third member is disposed between the first member and the second member to connect the first member to the second member and comprises a third inner surface configured to define an outer chamber communicating with the intermediate chamber.

6. The centrifugal device of claim 5, wherein the outer chamber surrounds the rotation axis and a portion of the intermediate chamber.

7. The centrifugal device of claim 6, wherein the first member comprises a first upper member comprising the first inner surface and a second lower member comprising a lower surface configured to define the outer chamber, and
the second member comprises a second lower member comprising the second inner surface and a second upper member comprising an upper surface configured to define the outer chamber.

8. The centrifugal device of claim 1, further comprising a connection part configured to connect the centrifugal part to the driving part,
wherein the driving part rotates the connection part and the centrifugal part.

9. A centrifugal device comprising a centrifugal part configured to provide an intermediate chamber into which a centrifugal object is put,
wherein the centrifugal part is rotated about a rotation axis passing through the intermediate chamber.

10. The centrifugal device of claim 9, wherein the intermediate chamber has a pot shape.

11. The centrifugal device of claim 9, wherein the centrifugal part comprises a first member and a second member,
wherein the first member comprises a first inner surface configured to define an upper side of the intermediate chamber, and
the second member comprises a second inner surface configured to define a lower side of the intermediate chamber.

12. The centrifugal device of claim 11, wherein the first inner surface and the rotation axis have an acute angle therebetween, and
the second inner surface and the rotation axis have an acute angle therebetween.

13. A centrifugal device comprising a centrifugal part,
wherein the centrifugal part comprises a first member and a second member,
the first member provides a first intermediate chamber through which a rotation axis of the centrifugal part passes,
the second member provides a second intermediate chamber through which the rotation axis of the centrifugal part passes, and
the first intermediate chamber and the second intermediate chamber communicate with each other.

14. The centrifugal device of claim 13, wherein the first member comprises a first inner surface configured to define the first intermediate chamber, and
the second member comprises a second inner surface configured to define the second intermediate chamber.

15. The centrifugal device of claim 14, wherein the first inner surface and the rotation axis have an acute angle therebetween, and
the second inner surface and the rotation axis have an acute angle therebetween.

16. The centrifugal device of claim 13, wherein the centrifugal part further comprises a bio-sensor coupled to the second inner surface.

17. The centrifugal device of claim 16, wherein the centrifugal part further comprises a support member provided with a valve that is opened downward.
